(19) United States
(12) Patent Application Publication
(10) Pub. No.: US 2004/0254798 A1
(43) Pub. Date: Dec. 16, 2004

(54) Real-time interactive stock quotes using a broadcast channel

(76) Inventor: Khoi Hoang, Pleasanton, CA (US)

Correspondence Address: T. Khan, Esq., PREDIWAVE CORPORATION, 48431 Milmont Dr., Fremont, CA, 94538, US

(21) Appl. No.: 10/286,395

(22) Filed: Nov. 1, 2002

Related U.S. Application Data
(60) Provisional application No. 60/337,571, filed on Nov. 30, 2001.

(51) Int. Cl. G06F 17/60

(52) U.S. Cl. 705/1

(57) ABSTRACT

These and other objects of the invention are provided by a method and system for real time display of time sensitive information. In a method of the invention, a first set of time sensitive information is received. A second set of information from the first set of time sensitive information is selected. The second set of information corresponds to a stored set of information identifiers. The second set of information is then stored. The second set of information is then displayed to a subscriber. In other embodiments of the invention, the time sensitive information includes stock quote information, news information, traffic information, or sports scores. The present invention can be implemented in a broadcast communication system such as a broadband communication system, wireless local loop or other communication system capable of broadcasting digital information.

### CROSS-REFERENCE TO RELATED APPLICATIONS

Reference is made and priority claimed to U.S. Provisional Application entitled REAL-TIME INTERACTIVE STOCK QUOTES USING A BROADCAST CHANNEL, filed Nov. 30, 2001, bearing application serial No. 60/337,571. This application is related to the following applications: Khoi Nhu Hoang's patent application entitled SYSTEMS AND METHODS FOR PROVIDING VIDEO ON DEMAND SERVICES FOR BROADCASTING SYSTEM filed on May 31, 2000, bearing application Ser. No. 09/584,382; Khoi Nhu Hoang's patent application entitled SYSTEMS AND METHODS FOR PROVIDING VIDEO ON DEMAND SERVICES FOR BROADCASTING SYSTEM filed on Nov. 10, 2000, bearing application Ser. No. 09/709,948; Khoi Nhu Hoang's patent application entitled UNIVERSAL DIGITAL BROADCAST SYSTEM AND METHODS filed on Apr. 24, 2000, bearing application Ser. No. 09/841,792; and Khoi Nhu Hoang's patent application entitled UNIVERSAL STB ARCHITECTURES AND CONTROL METHODS filed on May 30, 2001, bearing application Ser. No. 09/870,879 each of which is herein incorporated by reference for all purposes.

This application is also related to: U.S patent application by Barrett, et al. entitled USER-CENTERED PUSH METHODS AND SYSTEM, and bearing publication number US 2002/0152213 A1 filed on Oct. 17, 2002: and issued U.S. Pat. No. 5,872,921 entitled SYSTEM AND METHOD FOR A REAL TIME DATA STREAM ANALYZER AND ALERT SYSTEM, to Zahariev, et al., filed on Feb. 16, 1999, each of which is hereby incorporated herein by reference.

### FIELD OF THE INVENTION

The present invention relates to the field of digital communications. More particularly, the present invention relates to the distribution of real-time stock quotes using a broadcast channel.

### BACKGROUND OF THE INVENTION

The internet revolution has brought many things into offices and homes that were previously only available to very particular people. Among the things that the internet has made available to an ordinary consumer is the ability to receive specialized information such as stock quotes, news, weather, traffic and scores from sporting events. With regard to stock quotes, a prior art systems such as available from ETRADE or DATEK have made available stock quotes from stock exchange centers such as the New York Stock Exchange (NYSE), the NASDAQ stock exchange, or the American Stock Exchange (AMEX). Prior art systems such as these have allowed a subscriber to build a list of desired stock quotes for display to the user. Typically, the list of desired stock quotes is stored on a remote server. The remote server retrieves stock quotes from the list of desired stock quotes and then transmits such information for display to a subscriber. Such a remote server, however, is charged with processing many requests from many different subscribers. System performance can, therefore, be slow. The server must iteratively execute requests for information from many different users. Moreover, the server may process large lists of desired stock quotes for any particular subscriber. One of skill in the art understands that stock quotes are very time sensitive such that even a small delay in receiving accurate information can be detrimental to an investor.

In similar manners that stock quotes are time sensitive information, so are other types of information including, news, weather, traffic and scores. Just as there are individuals that value rapid and accurate stock information, so are there individuals that value news, weather and traffic. Prior art systems for providing such information to a subscriber have had similar deficiencies as described for stock quote systems.

Accordingly, there is a need in the art to provide information to a subscriber in a very rapid manner. Moreover, there is a need to simultaneously provide information to a group of subscribers. Also, there is a need to provide rapid and individualized information to a group of subscribers. These and other objects of the invention are described in the present disclosure.

### SUMMARY OF THE INVENTION

These and other objects of the invention are provided by a method and system for real time display of time sensitive information. In a method of the invention, a first set of time sensitive information is received. A second set of information from the first set of time sensitive information is selected. The second set of information corresponds to a stored set of information identifiers. The second set of information is then stored. The second set of information is then displayed to a subscriber. In other embodiments of the invention, the time sensitive information includes stock quote information, news information, traffic information, or sports scores.

The present invention can be implemented in a broadcast communication system such as a broadband communication system, wireless local loop or other communication system capable of broadcasting digital information.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 a block diagram of a system for broadcasting information from a stock exchange center or stock exchange service provider according to an embodiment of the invention;

FIG. 2 is a flow chart for selecting and displaying a set of desired stock quotes according to an embodiment of the invention;

FIG. 3A is a diagram of a computer system with a software interface for selecting stock quotes according to an embodiment of the invention;

FIG. 3B shows a software interface for selecting a desired stock quote according to an embodiment of the invention;

FIG. 3C shows a software interface for confirming the selection of a desired stock quote according to an embodiment of the invention;

FIG. 3D shows a software interface for selecting a desired stock quote according to an embodiment of the invention;

FIG. 3E shows a software interface for confirming the selection of a desired stock quote according to an embodiment of the invention;

FIG. 4A is a diagram of a set-top box system with a software interface for selecting stock quotes according to an embodiment of the invention;

FIG. 4B shows a software interface for displaying stock quotes in a tabular manner and overlaid over other visual information according to an embodiment of the invention;

FIG. 4C shows a software interface for displaying stock quotes in a banner below other visual information according to an embodiment of the invention;

FIG. 5 shows a server master stock information database in accordance with one embodiment of the present invention;

FIG. 6 shows an exemplary transmission spectrum for two channels broadcast in accordance with one embodiment of the present invention;

FIG. 7 shows a data packet including time sensitive stock information in accordance with one embodiment of the present invention;

FIG. 8 shows a video display of stock price information in conjunction with video broadcast display programs;

FIG. 9 shows an exemplary dedicated electronic program guide (EPG) channel at 650 including a detailed stock information sub-channel in accordance with one embodiment of the present invention;

FIG. 10A shows the format in which detailed stock description information is transmitted in accordance with one embodiment of the present invention;

FIG. 10B shows a display menu for selecting detailed stock information at 670 in accordance with one embodiment of the present invention;

FIG. 12 shows an STB process for updating a user stock price database at 800 in accordance with one embodiment of the present invention; and

FIG. 13 shows an exemplary statistical histogram generated by software residing on STB 402 (FIG. 4A) in accordance with one embodiment of the present invention.

### DETAILED DESCRIPTION OF THE PREFERRED EMBODIMENTS

There exist many types of time sensitive information including stock quotes, news, weather, traffic and sports scores. At present, stock quotes are the most time sensitive information of interest to the largest group of people. Accordingly, the present disclosure will use stock quotes as a particular example. One of skill in the art, however, will understand that the present disclosure is applicable to many types of information of interest to groups of people.

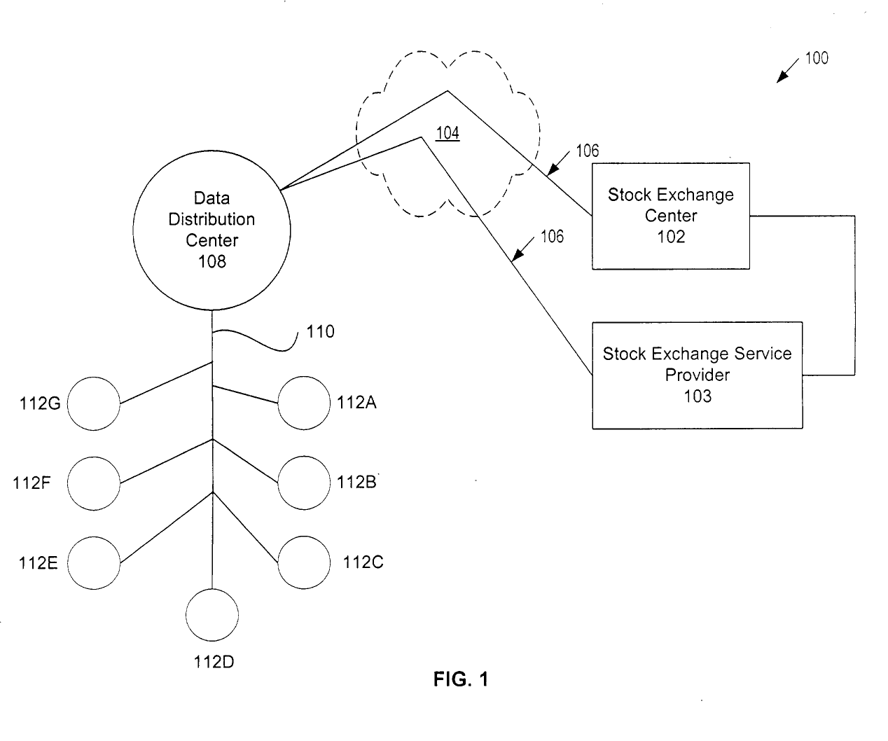

FIG. 1 is a block diagram representation of a system 100 for real-time distribution of stock quotes on a broadcast channel. As shown in FIG. 1, there is shown a stock exchange center 102 in communication with a distribution center 108 further in communication with subscribers 112A-G. Stock exchange center 102 is, for example, one of the three major stock exchanges in the United States (i.e., the New York Stock Exchange, the NASDAQ stock exchange or the American Stock Exchange). Other stock exchanges, either foreign or domestic, would also be appropriate for use in the present invention. As is known in the art, these types of stock exchanges operate to facilitate the trade of stocks between buyers and sellers. In facilitating such an exchange, stock exchange centers 102 provide trading prices of stocks. Such trading prices can include bid, ask and sell prices and can include other similar information. In providing stock prices, stock exchange centers 102 further offer information services that include stock prices for all or many of the stocks being traded on their exchange. In providing such information, stock exchange centers 102 also can transmit the information to a stock exchange service provider 103. For purposes of the present invention, however, information provided by stock exchange service provider 103 can be substituted for or supplemented by the information provided directly by stock exchange center 102. Moreover, stock exchange service provider 103 can receive information from multiple stock exchange centers 102. Accordingly, in an embodiment of the invention data distribution center 108 receives information from multiple stock exchange centers 102 and multiple stock exchange service providers 103. For clarity of description, the system with stock exchange center 102 will be further described, however, one of skill in the art will appreciate that other embodiments are possible.

Referring to FIG. 1, stock exchange center provides stock prices over a communication link 106. Communication link 106 is, for example, a high speed digital link such as a fiber optic link. Moreover, communication link 106 can be provided over a communications network 104. Communications network 104 can be provided over a telephone network or over any other widely distributed network such as the Internet. Moreover, where applicable, network 104 can be a wide area network (WAN) or local area network (LAN). One of skill in the art, along with the teachings of the present invention, will appreciate other embodiments of the invention with variations of network 104.

Communications link 106 therefore provides for communication between stock exchange center 102 and a data distribution center 108. Data distribution center 108 is configured to receive, collect and broadcast information received from stock exchange center 102. Moreover, where data distribution center 108 receives information from various stock exchange centers 102 or various stock exchange service providers 103, all received information can be collected and broadcast as will be described. For purposes of clarity of description, the information collected by data distribution center will be called “collected information.”

The collected information, is then transmitted over broadcast channel 110. Broadcast channel 110 is preferably a high speed digital network with error correction and detection codes. In an embodiment of the invention broadcast channel 110 is a broadband cable channel. Where the broadcast channel 110 is a broadband cable system, collected information can be transmitted on an EPG channel or can be merged into other channels such as those used for transmission of digital movies or digital music or text-on-demand. Transmission of collected information over broadcast channel 110 is achieved using methods known in the art including packet transmission of digital information. Moreover, broadcast channel 110 can be used to continuously transmit information in a constant or variable bandwidth channel. In another embodiment of the invention, broadcast channel 110 is a wireless digital link or wireless local loop as further known in the art.

Broadcast channel 110 is available to various subscribers 112A-G. Broadcast channel 110 therefore provides the same collected information to all subscribers 112A-G. All subscribers 112A-G may not necessarily want to digest all the collected information. Moreover, the various subscribers 112A-G may not all want to digest the same subset of collected information. Accordingly the present invention, provides subscribers 112A-G with methods for tailoring received information as desired by each subscriber 112A-G.

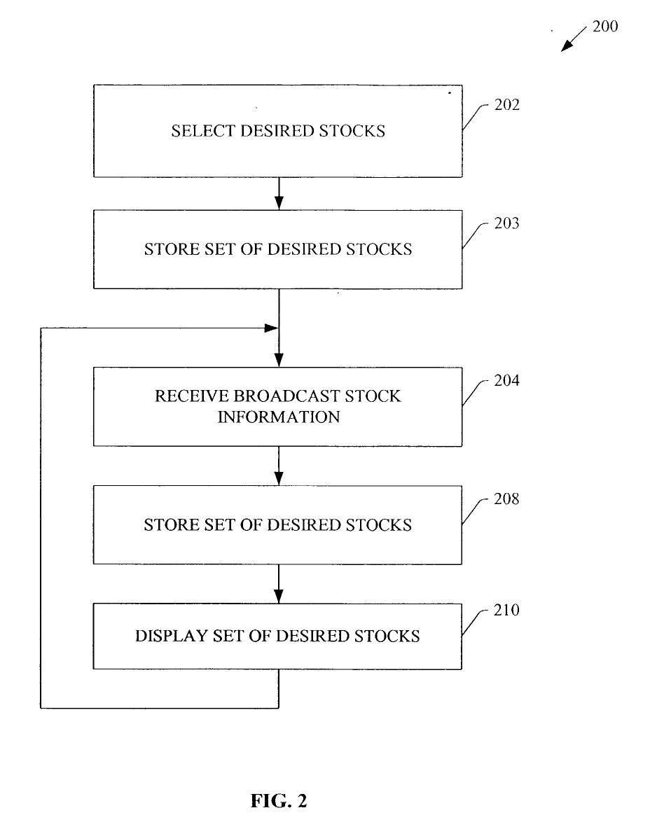

Shown in FIG. 2 is a method 200 for selecting and displaying a subset of desired stock quotes. At step 202, a subscriber selects the stock quotes he desires to display. In an embodiment of the invention, the subscriber selects stocks from stocks traded on one or mores stock exchanges. At step 203, the subscribers selection is stored as a set of desired stocks. Stock information broadcast over a communication channel such as described with reference to FIG. 1 is then received at step 204. The broadcast information contains information about the set of desired stock, but also contains information about many other stocks not of interest to the subscriber. Accordingly, at step 206, the set of desired stocks is retrieved from the broadcast stock information. At step 207, the set of desired stocks is then stored locally. Where method 200 is implemented on a microprocessor-based system, storage of the set of desired stocks can be done in random access memory (RAM) or on a hard disk drive (HDD). Other mediums for storing such information as known to one of skill in the art are also appropriate. The stored set of desired stocks is then displayed to the subscriber at step 208. In an embodiment of the invention, the display of the set of desired stocks is shown to the subscriber on a computer or television monitor. Moreover, the set of desired stocks can be displayed as a table of information, as a scrolling banner, or any other manner known to one of skill in the art.

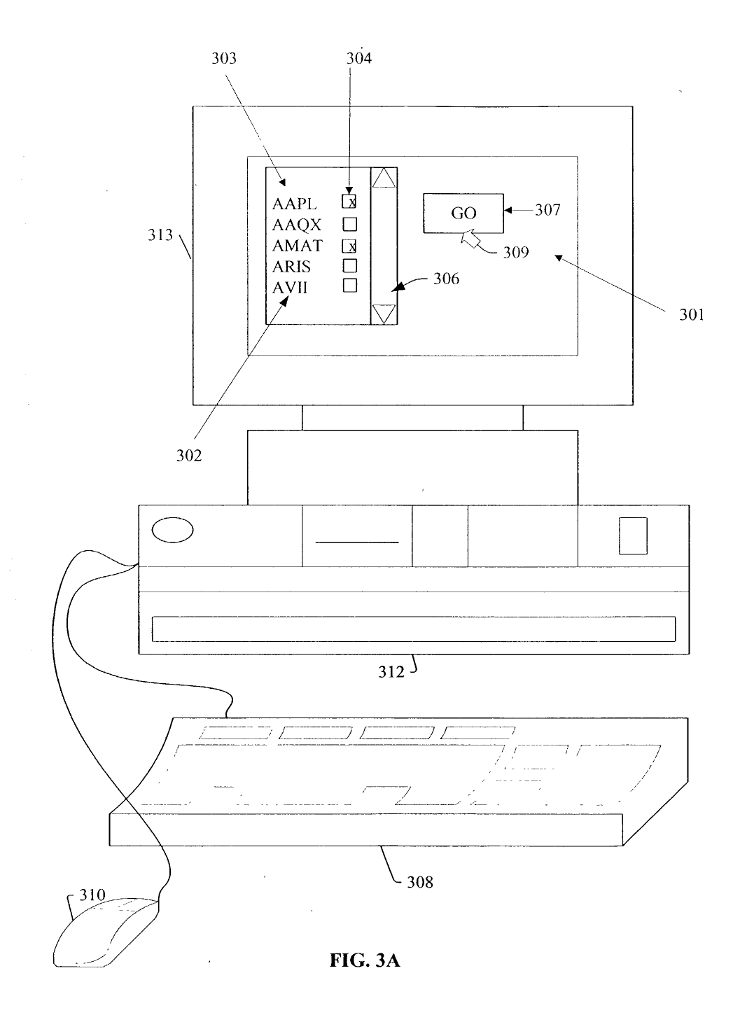

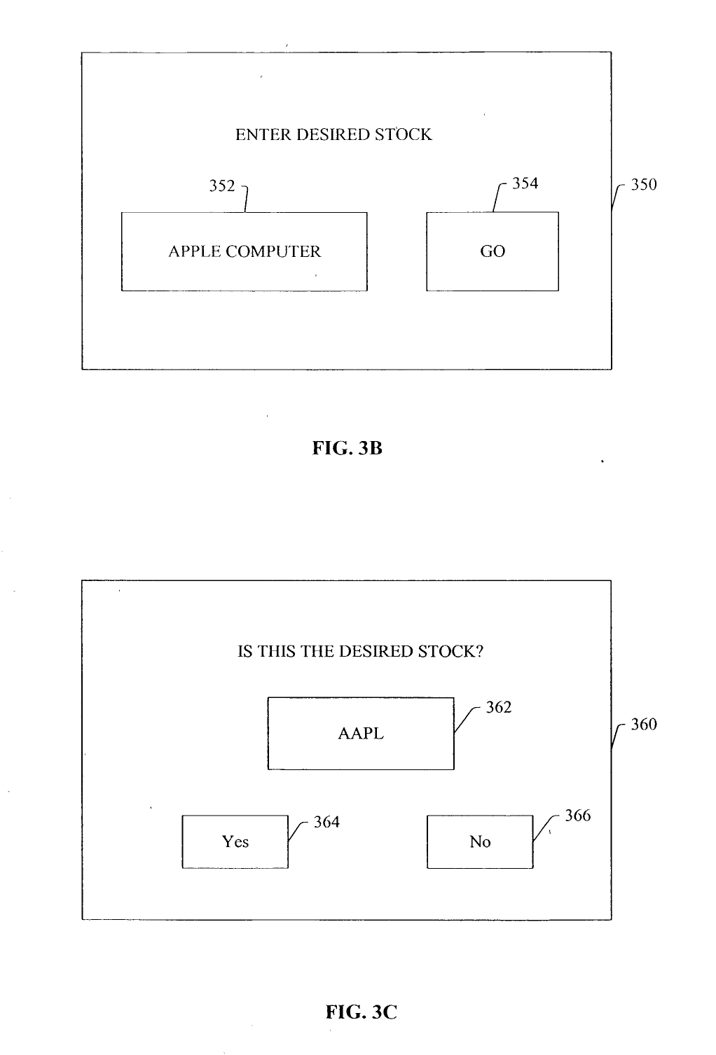

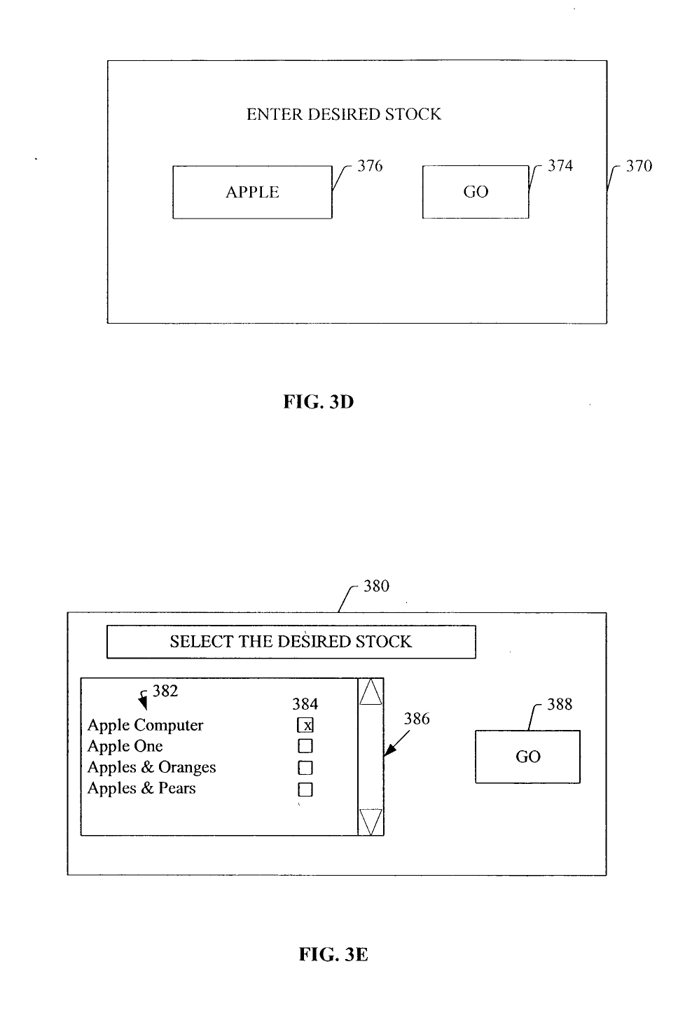

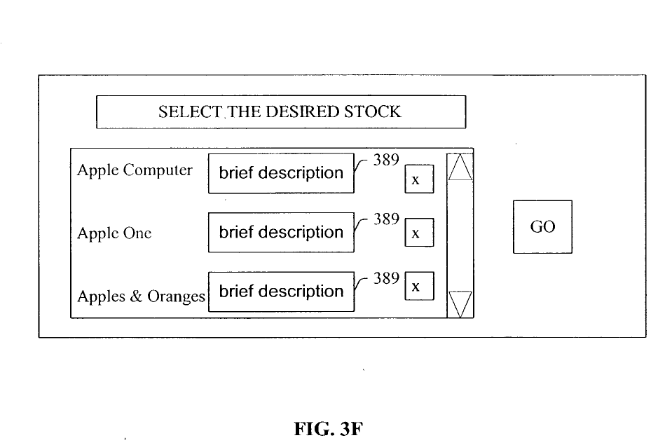

In an embodiment of the invention, a microprocessor-based computer system 300 is coupled to broadcast channel 110. As shown in FIG. 3A, computer system 300 includes a central processing unit (CPU) 312, a monitor 313, a keyboard 308 and a mouse 310. CPU 312 contains within it a microprocessor and memory. The microprocessor is used to execute certain software as will be further described. The memory is used to store such software and is further used to store information as will be described further below. A subscriber using computer system 300 is provided as software interface 301 for selecting his set of desired stocks. In an embodiment of the invention, a subscriber is provided with a software interface 301 providing a list 302 of all the available stocks 303 with accompanying check-boxes 304. Where a subscriber wishes to include a particular stock in his desired set of stocks, the subscriber maneuvers a cursor 309 using mouse 310 to check the desired check-box. To confirm a subscriber's selection, a confirmation button 307 is provided. Upon selecting a stock, the subscriber can confirm his selection by clicking on button 307 indicated as a “GO” button. All the available stocks can likely not be shown in one screen. Accordingly, scroll bars 306 are provided for viewing the entire list of stocks.

In accordance with one embodiment of the present invention software interface 301 also provides the subscriber a brief narative along with each stock name listing. This brief narrative could include information such as 52 week high, 52 week low, company market cap, company nationality, income to debt ratio, years in business, etc. The type of information included in the narrative could be customized by the subscriber based on what information was believed to be most useful to that individual. In accordance with one embodiment a subscriber could elect to receive more detailed information about a potential stock and the company the stock represents. This election could be accomplished by double-clicking on the stock name with the cursor 309, or by checking an additional box reserved for the selection of detailed descriptions. This detailed information could include any information having any bearing on stock valuation such as corporate debt; earnings; debt to earnings ratio, corporate assets, news, pending lawsuits, government sanctions, corporate structure, the identity of corporate officers and other important personnel, type of products and service offered by a company, etc.

In another embodiment of the invention, a software interface 350 as shown in FIG. 3B is provided for entering the name or stock identifier of a stock. A user enters a desired stock in field box 352 and then clicks on confirmation button 354 shown as a “GO” button. Software interface 360 is then displayed to a user as shown in FIG. 3C. Where the entered stock quote is found, the user is asked to confirm that the found stock is indeed the desired stock. As shown, the found stock 362 is displayed to a subscriber. If this is the correct stock, the subscriber selects button 364 shown as a “YES” button; where the found stock is incorrect, the subscriber selects button 366 shown as a “NO” button. Upon verifying that an entered name is the stock of interest, such stock can be included in the desired set of stocks. Where an entered stock is not found appropriate error messages can be displayed to a subscriber. Subsequently, the user can again be presented with software interface 350.

In another embodiment of the invention, a subscriber is presented with software interface 370 as shown in FIG. 3D. Software interface 370 allows a user to enter a partial name of a company or stock in field 376. For example, as shown in FIG. 3D a subscriber has entered the name “Apple.” Upon selecting button 374 shown as a “GO” button, software interface 380 as shown in FIG. 3E is presented to the subscriber. Software interface 380 displays a list 382 of stocks meeting the entered criteria. For the “Apple” example, Apple Computer, Apple One, Apples and Oranges, and Apples and Pears meet the entered criteria. Corresponding to the each stock in the list 382 of stocks are check boxes 384. The subscriber can then select stocks by selecting the corresponding check boxes 384. Moreover, the subscriber can confirm his selection by selection confirmation button 388 shown as a “GO” button.

FIG. 3F shows an alternative selection menu in which a brief description of the company associated with each stock is included in the menu. Such a description 389 could include the general industry or product the company produces and could aid a user in selecting stocks to monitor. In accordance with one embodiment of the present invention a user could search for types of stocks or companies using various criteria contained in such a brief description. Such a search could return a menu including all semiconductor processor manufacturers, all international airlines, etc. In this way a user could immediately have access to the stocks of an selected industry in which rapid and immanent growth is expected. Such brief description data would be transmitted separately of time sensitive stock price data on a channel or sub-channel dedicated to such information. In accordance with one embodiment such data would be transmitted on a sub-channel of an electronic program guide (EPG) channel.

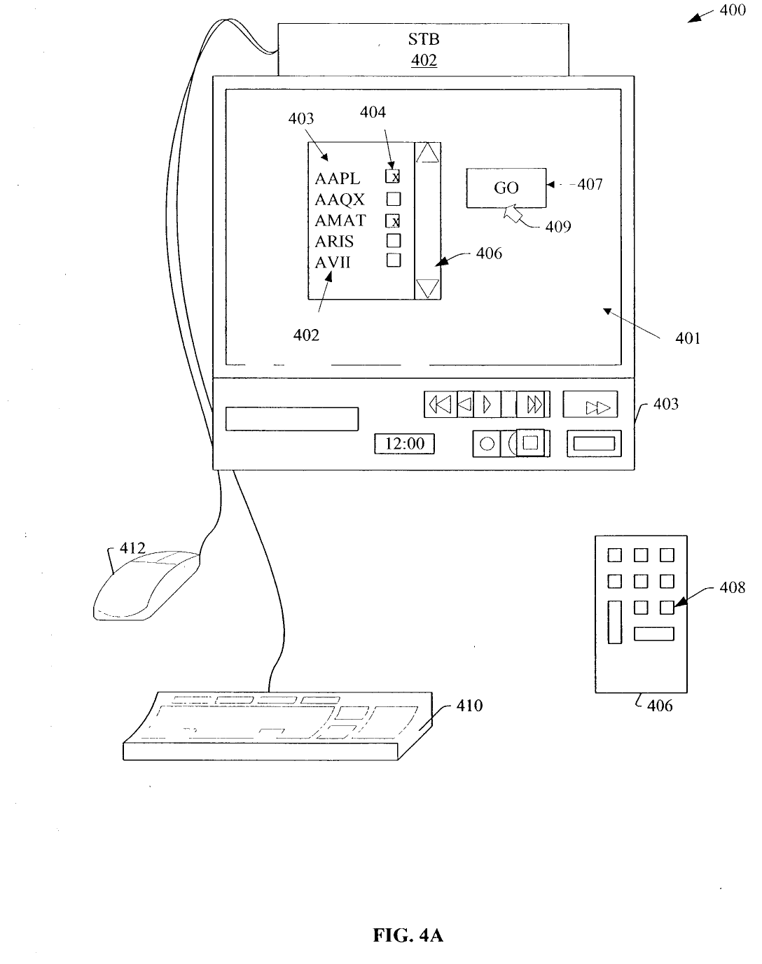

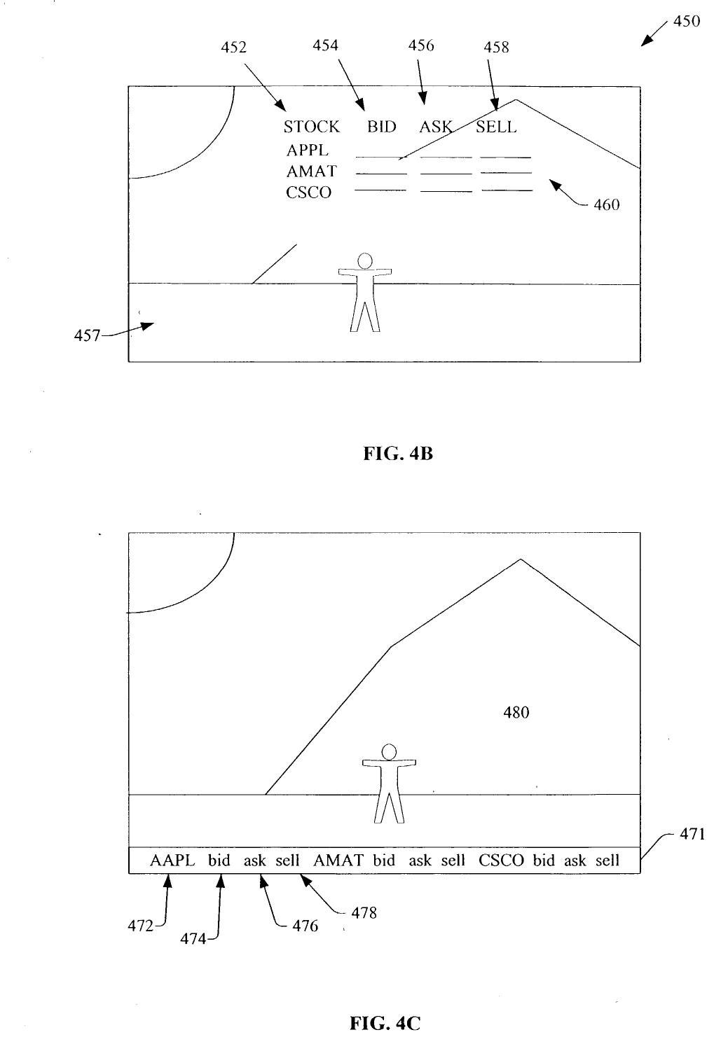

In another embodiment of the invention, a microprocessor-based set top box (STB) system 400, not necessarily a typical computer system, is coupled to broadcast channel 110. In this embodiment of the invention, the microprocessor based STB system 400 includes an STB 402 configured to interface with a television monitor 404 or VCR 403 as shown in FIG. 4A. STB 402 is further configured to receive information from a broadcast channel such as from a broadband cable system. STB 402 can be configured to receive digital movies or other digital information for display on a television monitor. Moreover, STB 402 is configured to receive broadcast stock information for display on television monitor 404. In this embodiment of the invention, a subscriber is provided software interface 401 for selecting his set of desired stocks. In an embodiment of the invention, a subscriber is provided with software interface 401 providing a list 402 of all the available stocks 403 with accompanying check-boxes 404. Where a subscriber wishes to include a particular stock in his desired set of stocks, the subscriber checks the check-box. All the available stocks can likely not be shown in one screen. Accordingly, scroll bars 406 are provided for viewing the entire list of stocks. In an embodiment of the invention, a keyboard 410 and mouse 412 are coupled to STB 402 such that STB system 400 is very similar to computer system 300 as described with reference to FIG. 3. In such an STB system 400, the various software interfaces described with reference to FIG. 3 are also appropriate for STB system 400. As shown in FIG. 4A, software interface 401 is very similar to software interface 301. Even if STB system 400 is not provided with keyboard 410 or mouse 412, remote control device 406 can be used as an input device. In an embodiment of the invention, remote control device 406 is used for software interfaces such as software interface 401. In another embodiment of the invention, the buttons 408 on remote control device 406 are used to enter information on a software interface. Buttons 408 can be used to enter text using a predetermined scheme disclosed to the subscriber. Moreover, buttons 408 are used to maneuver within software interfaces using predetermined buttons to maneuver a cursor 409.

In an embodiment of the invention, STB system 400 is used to display movies or other visual information on television monitor 404. Moreover, an embodiment as shown in FIG. 4B displays an image 450 that includes a table 460 of stock information overlaid on visual information 457 such as a live television broadcast or pay-per-view movie being displayed on television monitor 400. Table 460 includes a column 452 of stock names, a column 454 of bid prices, a column 456 of ask information, and a column 458 of sell information. Other information can also be displayed on table 460.

In yet another embodiment of the invention, image 470 is displayed that includes a scrolling banner 471 of stock information below visual information 480 being displayed on television monitor 400. Scrolling banner 471 includes various instances of stock name 472, bid price 474, ask price 476 and sell price 478. As for table 460, other information can also be displayed on scrolling banner 471.

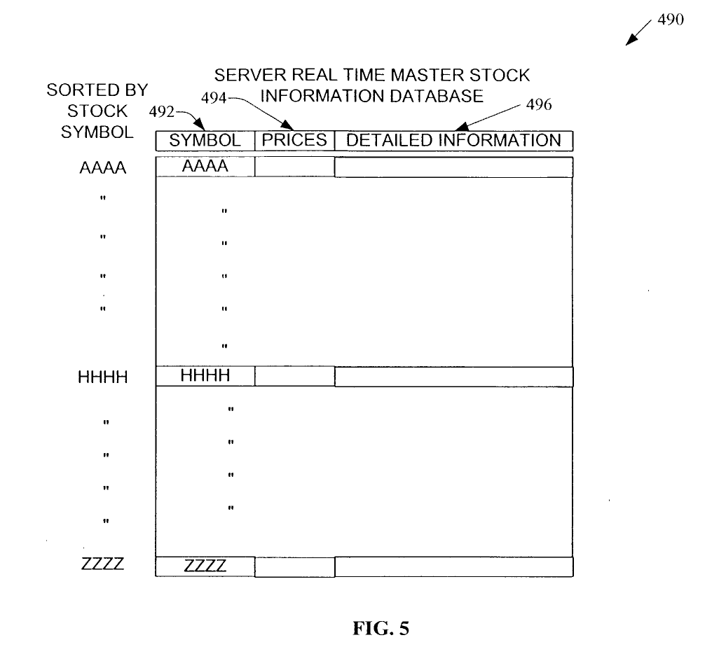

FIG. 5 shows a server master stock information database in accordance with one embodiment of the present invention at 490. In accordance with the present embodiment data distribution center 108 (FIG. 1) receives information from multiple sources for inclusion in a database 490.

In accordance with one embodiment data distribution center 108 receives stock market information from one or more stock exchange service providers and one or more stock exchange centers in order to compile a real-time master stock information data base 490. Such a stock information database 490 stores various stock information such as stock symbol 492, real time stock price 494 and detailed information 496 relating to a company associated with symbol 492. In accordance with one embodiment stock symbol information 492 includes a company name associated with an actual stock symbol. In accordance with such an embodiment a stock symbol could be accessed by entering the name of a selected company.

In accordance with one embodiment real time stock price 492 is updated whenever there is a change in stock price indicated by either the stock exchange service provider 103 or stock exchange centers 102. In accordance with such an embodiment information coming from various sources would be merged in database 490 with newer information replacing old information. A record of changes and the source of changes may also be kept to track such information over time.

Stock price 492 may include any of the time sensitive prices associated with a particular stock such as bid, ask, last price, etc. In accordance with one embodiment stock price may also include the price of various option contracts and the quantity and dates of such contracts. Detailed information 496 may include any information an investor would find valuable in determining the value of a company including market cap, gross revenue, assets, debt, valuation, analyst reviews, press releases, news, etc. Such information may also include information such as a corporate stance on the environment, worker health, child labor, etc.

In accordance with one embodiment the information in database 490 is organized by stock symbol, and may be retrieved and updated by searching for stock symbols alphabetically. Any time new information pertaining to a stock symbol is received by distribution center 108 (FIG. 1) the stock symbol 492 is looked up alphabetically and price 494 and or detailed information 496 is updated.

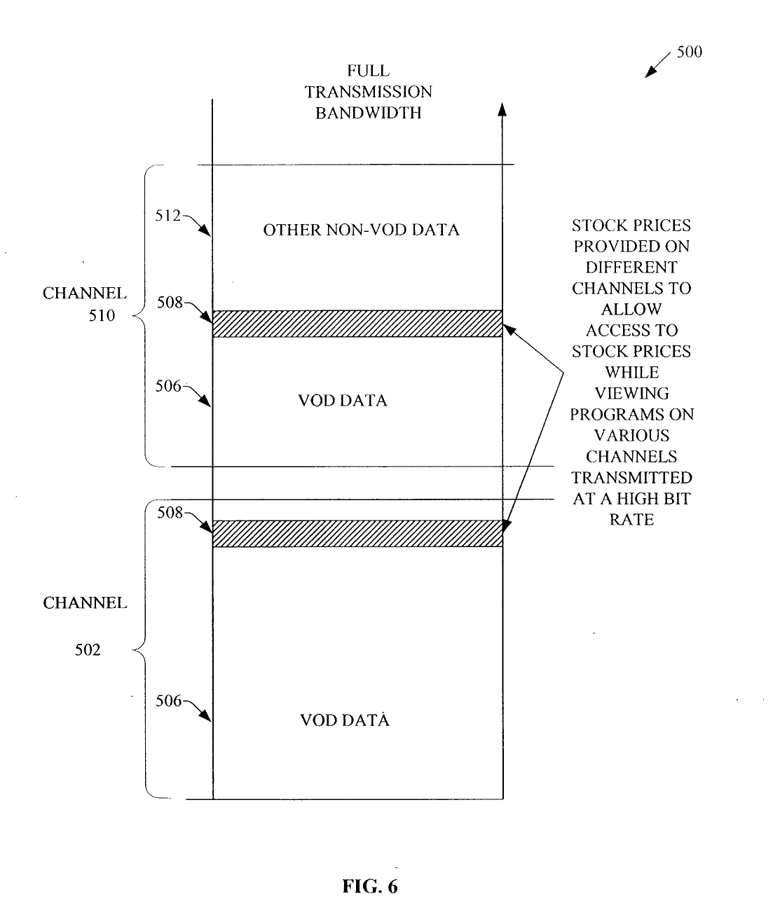

FIG. 6 shows an exemplary transmission spectrum for two channels broadcast in accordance with one embodiment of the present invention at 500. A first channel 502 includes one or more subchannels of video-on-demand (VOD) data 506 and time sensitive stock data 508. Second channel 510 includes one or more subchannels of VOD data 506, time sensitive stock data 508 and one or more subchannels of Non-VOD data 512. Though only two channels are shown in FIG. 6, it is assumed that 30 or more channels are available on an exemplary system.

Time sensitive stock data 508 is transmitted on multiple channels 502, 510 in order to allow a receiving set-top-box to access stock information while a user is watching a program on various channels. For example, a user could watch a DOD movie on first channel 502 and then switch to a non-DOD broadcast program available on second channel 510 without losing access to time sensitive stock information 508. In this way a client of such a universal broadcast system could watch various movies, television programs, etc., all the while having a customized banner showing the latest stock prices of stocks in which he or she is interested.

In accordance with one embodiment stock data 508 is contained on a dedicated subchannel 508 of a plurality of broadcast channels 502, 510. Alternatively stock data 508 may be contained on a portion of a subchannel carrying multiple data programs.

In accordance with one embodiment detailed stock information is provided on an electronic program guide channel (EPG). Such detailed stock information would be transmitted at a much lower bit rate than the above described time sensitive stock price information. In accordance with one embodiment users may trade stocks using software residing on a set-top-box receiver and information provided as stock data 508.

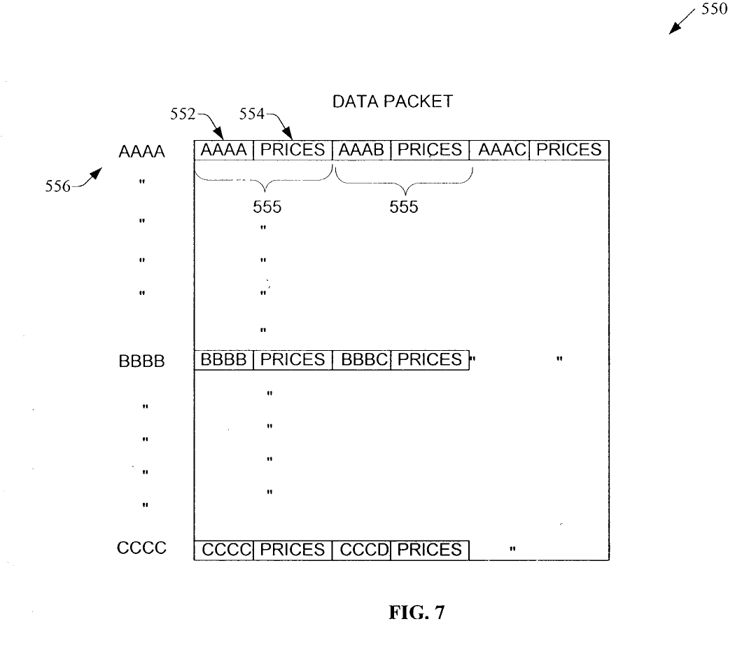

FIG. 7 shows a data packet including time sensitive stock information in accordance with one embodiment of the present invention at 550. Exemplary data packet 550 includes a plurality of stock symbol fields 552 each having a corresponding price field 554. Each stock symbol field will be of the same size as will each price field. In this way each symbol field 552 and corresponding price field 554 will comprise a virtual sub-packet, 555 with the data packet 550 including a fixed number of these virtual sub-packets 555. Each virtual sub-packet 555 will be of a fixed size in order to simplify sorting and retrieval both at the server side and the receiver side.

Each stock symbol field 552 will contain information including a stock symbol indicative of a company stock such as CSCO, which would indicate stock of the company Cisco Systems, inc. Stock symbol field 552 would also contain the identity of the company associated with the stock symbol. Price field 554 would contain information such as the ask price, bid price, last price, etc. for the associated stock symbol.

In accordance with one embodiment price field 554 would also include information relating to option contracts available for a stock symbol. Such information would include the amount of stock for each such contract available, price of each contract, time period of each such contract, etc.

The sub-packets 555 are arranged in the data packet 550 alphabetically by stock symbol 556. Since only a limited number of sub-packets 555 could be carried by data packet 550 it would be necessary to send the stock price information using multiple data packets 550. An efficient method for grouping stock symbols 552 is to assign an alphabetic range to each data packet 550. An exemplary data packet 550 shows stock symbols ranging from AAAA to CZZZ. Additional data packets would be necessary for stock prices relating to stock symbols DAAA through ZZZZ.

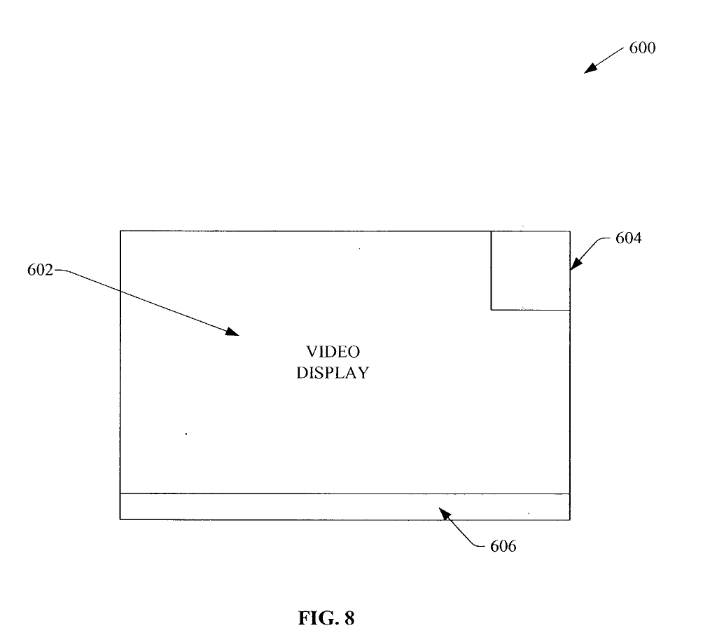

FIG. 8 shows a video display of stock price information in conjunction with video broadcast display programs at 600. A video program such as a video-on-demand (VOD) movie is displayed in a central portion 602 of a video display device 600. Simultaneously, current stock prices for a selected group of stocks is displayed in a peripheral area 604 of the video display device 600. These current stock prices may be displayed as text over a portion of movie, or may be displayed as text in a picture in picture format, or any other suitable format.

In accordance with one embodiment selected stock prices are displayed across the bottom of a display screen 600 as a banner display 606. Such a display 606 would appear as similar to that used by CNN headline news to display recent events, though the content of a banner in accordance with the present invention would be customizable by a user to display prices for selected stocks, currency, negotiable instruments, commodities, option contracts and the like.

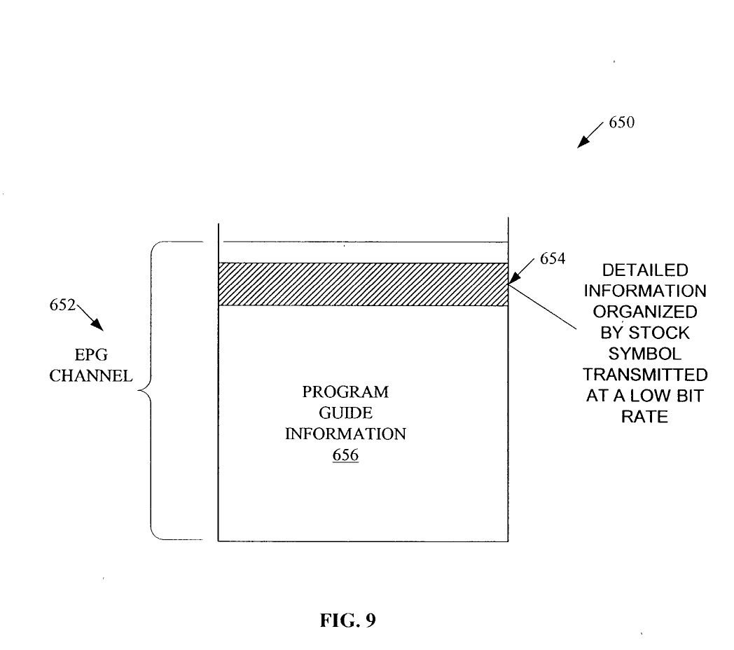

FIG. 9 shows an exemplary dedicated electronic program guide (EPG) channel at 650 including a detailed stock information sub-channel in accordance with one embodiment of the present invention. EPG channel 652 includes stock information sub-channel 654 and program guide data 656. In accordance with one embodiment stock information sub-channel 654 carries detailed information on all publicly traded stocks. This detailed information includes information having any bearing on stock valuation such as corporate debt; earnings; debt to earnings ratio, assets, news, pending lawsuits, government sanctions, corporate structure, the identity of corporate officers and other important personnel, type of products and service offered by a company, etc. In accordance with one embodiment detailed stock information sub-channel 654 carries information transmitted at a low bit rate (relative to the transmission bit rate of time sensitive information such as that illustrated with reference to FIG. 6 above).

In accordance with one embodiment of the present invention EPG information 656 comprises information relating to the broadcast services offered by a universal broadcast server system (not shown) including VOD services and Non-VOD programs such as broadcast television. Such EPG information is described in greater detail with reference to Khoi Hoang's patent applications entitled: UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, each of which is hereby incorporated by reference.

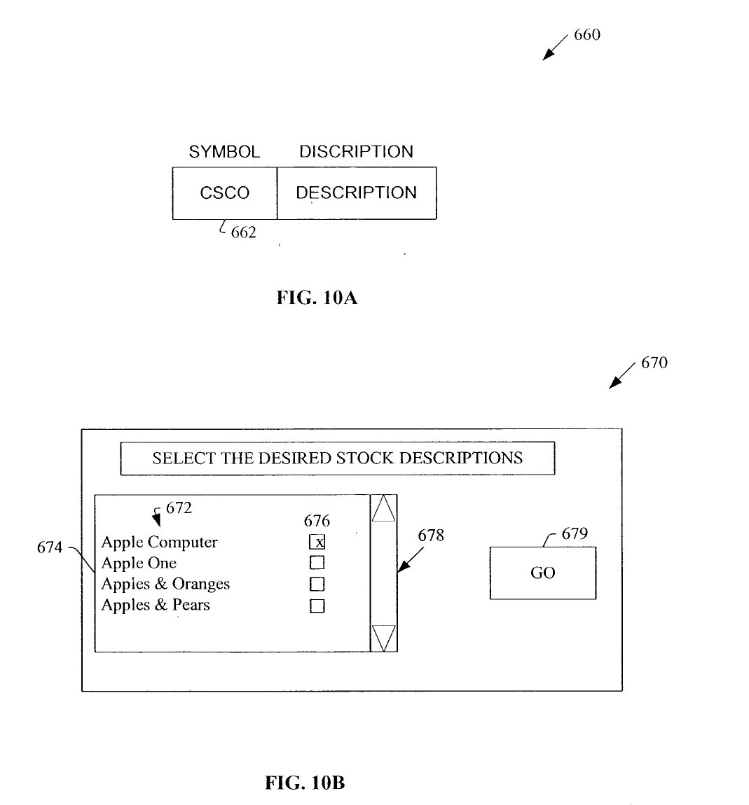

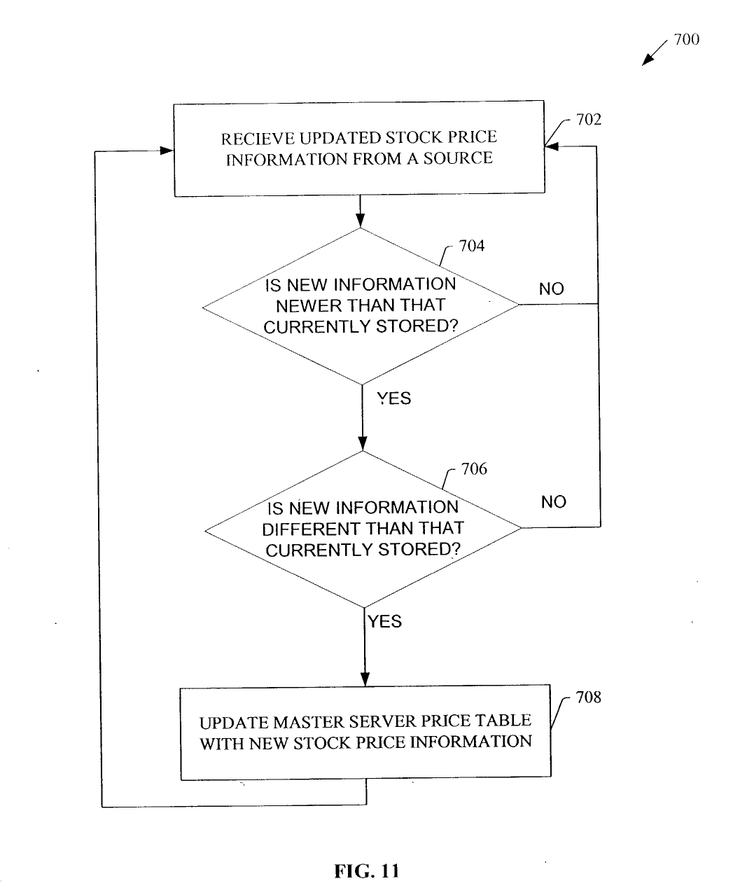

FIG. 10A shows the format in which detailed stock description information is transmitted in accordance with one embodiment of the present invention. Information 660 such as corporate debt, assets, news, pending lawsuits, government sanctions, corporate structure, the identity of corporate officers and other important personnel, type of products and service offered by a company, etc., is transmitted with each associated stock symbol header 662. The information is transmitted such that a receiving STB 402 (FIG. 4A) may maintain a database of detailed stock information. A user could access the information from this stored database at any time. In accordance with one embodiment detailed stock information 660 includes a history of stock prices for each stock symbol.

FIG. 10B shows a display menu for selecting detailed stock information at 670 in accordance with one embodiment of the present invention. A user may select a company 672 from a menu 674 by checking a box 676. A user may scroll through a list of all publicly traded companies using scroll bar 678. Once a user has selected all the detailed descriptions desired for viewing, the user need only click a bar 679.

FIG. 11 shows a server process for updating a stock price information data base at 750 in accordance with one embodiment of the present invention. In a step 752 distribution center 108 (FIG. 1) receives updated stock price information. This information could come from a stock exchange service provider 103 (FIG. 1), a stock exchange center 102, or any other suitable source of reliable stock price information. Such information may include last price, ask price, bid price, etc.

In a step 754 the distribution center 108 determines whether the update information is newer than the relevant information currently stored for the particular stock. If the update information is newer the distribution center 108 determines whether the update information differs from the currently stored information for the relevant stock. If the update information is different the distribution center 108 updates the entry in a master stock price database associated with the stock in question.

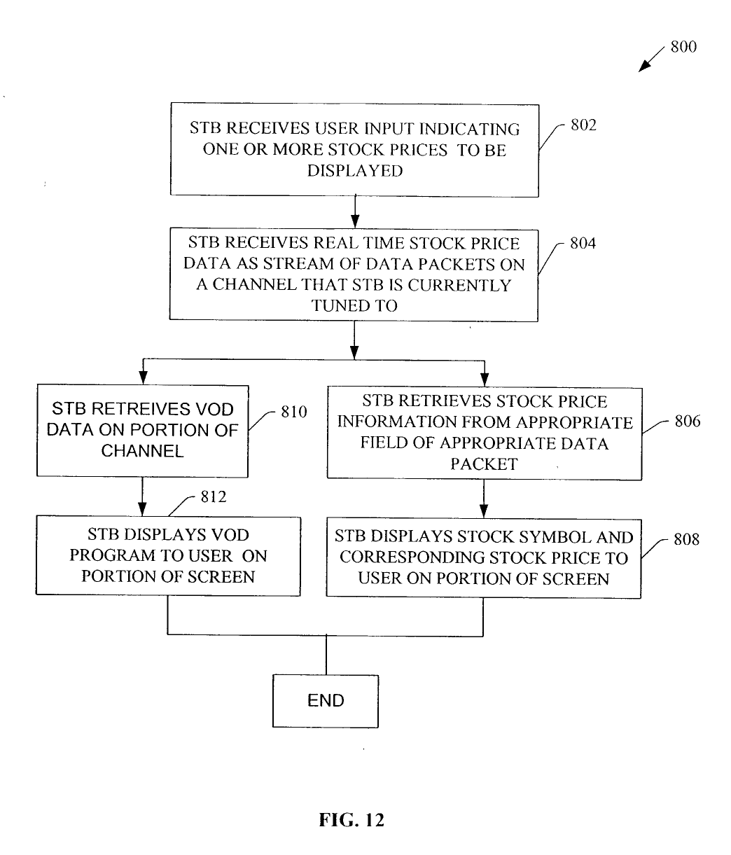

FIG. 12 shows an STB process for updating a user stock price database at 800 in accordance with one embodiment of the present invention. STB 402 (FIG. 4A) receives user input indicating one or more stock symbols for display in step 802. Step 804 STB receives real time stock price data 506 (FIG. 5) as data packets 550 (FIG. 6) on a channel 504 or 502 (FIG. 5) that STB is currently tuned to. In step 806 STB 402 (FIG. 5) retrieves stock price information from an appropriate price field 554 (FIG. 7) of an appropriate data packet 550 including each stock selected in step 802. In order to retrieve the correct stock price STB 402 searches alphabetically 556 (FIG. 7) for selected symbol 552 (FIG. 7), and retrieves an associated price information 554 (FIG. 7).

In step 808 the STB displays the selected stock symbols and corresponding stock price information to the user on a portion of the video display screen 604 or 606. Concurrently in step 810 the STB is retrieving VOD data on a portion of channel 502 or 504 (FIG. 5) separate from stock price data 506 (FIG. 5). Concurrently with step 808 the STB displays this VOD data as a video program to the user on a central portion 602 (FIG. 6) of the video display screen in step 812. Thus VOD data and stock price information are displayed simultaneously.

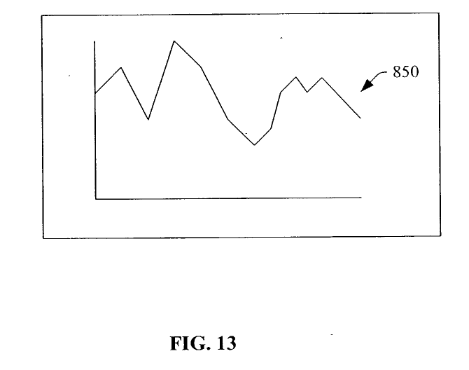

FIG. 13 shows an exemplary statistical histogram generated by software residing on STB 402 (FIG. 4A) in accordance with one embodiment of the present invention. The exemplary histogram 850 illustrates frequency that which various stocks have been selected for viewing by the user over time.

In accordance with one embodiment software residing on the STB 402 (FIG. 4A) may be operative to generate various statistical graphs such as plots of stock prices over time, plots of trade volume of selected stocks over time, etc. Virtually any conceivable data analysis could be performed by software residing on the STB 402 (FIG. 4A) or the computer 312 (FIG. 3A). Potentially, even deriving virtual mathematical models of price variations could be used to try to predict future behavior based solely on mathematical modeling, or a combination of mathematical modeling and other factors such as analysts ratings, earnings forecasts, etc.

Several preferred embodiments of the present invention have been described. Nevertheless, it will be understood that various other modifications may be made to the described invention without departing from its spirit and scope. For example, the present invention is not limited to any particular implementation or programming technique, and the invention may be implemented using various techniques for achieving the functionality described herein. The invention may be implemented in any appropriate operating system using appropriate programming languages and/or programming techniques. Thus, the present invention is not limited to the presently preferred embodiments described herein, but may be altered in a variety of ways which will be apparent to persons skilled in the art based on the present description.

1. A method for broadcasting time sensitive information to a plurality of users, comprising the acts of:
collecting time sensitive information including a first set of information and a second set of information;
broadcasting said time sensitive information to a plurality of users in a client generic format such that a first user may select said first set of information without selecting said second set of information.

2. The method of claim 1 wherein said first user accesses said first information without bi-directional communication with a broadcast service provider.

3. The method of claim 1 wherein said time sensitive information includes financial information such as interest rates.

4. The method of claim 1 wherein said time sensitive information includes stock market information.

5. The method of claim 3 wherein said financial information includes the federal prime commercial lending rate.

6. The method of claim 1 further comprising broadcasting digital video data to said plurality of users in a client generic format in order to enable said selecting user to simultaneously view said time sensitive information and video images corresponding to said digital video data.

7. The method of claim 6 wherein said time sensitive information is displayed over a portion of said video images.

8. The method of claim 1 wherein said time sensitive information includes a plurality of stock price quotes.

9. The method of claim 1 wherein said collecting of time sensitive information includes collecting said first of information from a first source and said second set of information from a second source.

10. The method of claim 9 wherein said first source is a stock exchange center and said second source is a stock exchange service provider.

11. The method of claim 9 wherein said first and second sources are chosen from a group consisting essentially of governmental agencies, businesses, news services and financial institutions.

12. The method of claim 1 further comprising broadcasting said time sensitive information redundantly on a plurality of channels in order to enable users to access said time sensitive information while tuned to any one of said plurality of channels.

13. The method of claim 1 further comprising broadcasting digital video data to said plurality of users in a client generic format.

14. The method of claim 13 wherein said digital video data includes video-on-demand data broadcast such that a receiving user may access a selected video program within a predetermined time period of selecting said video program.

15. The method of claim 14 wherein said video-on-demand data broadcast includes a sequence of data blocks of said selected video program, wherein a first data block may be accessed at any selected time period.

16. The method of claim 1 wherein said first user must possess an authorization in order to access said time sensitive information.

17. The method of claim 1 further comprising broadcasting a disabling code corresponding to a selected data receiver and operative to prevent said selected data receiver from accessing said time sensitive information.

18. The method of claim 17, wherein said disabling code corresponds to an identity code associated with said selected data receiver.

19. The method of claim 1 further comprising broadcasting detailed time insensitive information to said plurality of users in a client generic format, wherein said detailed time insensitive information is combined with said time sensitive information in order to provide both detailed information and time sensitive information associated with a user selection.

20. The method of claim 19 wherein said user selection is a symbol corresponding to equity in a publicly traded entity, and wherein detailed information and time sensitive information associated with said publicly traded entity are provided to a selecting user.

21. The method of claim 20 further comprising broadcasting digital video data to said plurality of users in a client generic format such that said selecting user may simultaneously view said time sensitive information and video images corresponding to said digital video data.

22. The method of claim 1 wherein said time sensitive information includes a plurality of information entries corresponding to a plurality of identifiers, wherein said time sensitive information is broadcast as a sequence of data packets, wherein each data packet includes a portion of said plurality of information entries.

23. The method of claim 22 wherein said each said information entry corresponds to a one of said plurality of identifiers.

24. The method of claim 23 wherein each said identifier is a stock symbol and each said information entry is a price, such that each stock symbol corresponds to at least one price.

25. A broadcast server system for providing time sensitive information to a plurality of clients comprising:
a data distribution center communicatively coupled with at least one source of time sensitive information;
a data base for storing said time sensitive information;
a transmission system for providing said time sensitive information via a transmission medium to said plurality of clients in a client generic format such that a client selects a portion of said time sensitive information for viewing in conjunction with a video program.

26. The system of claim 25 wherein said transmission system is operative to provide digital video data to said plurality of clients such that said selecting client may simultaneously view said time sensitive information and video images corresponding to said digital video data.

27. The system of claim 25 wherein said selected portion of said time sensitive information is displayed over a portion of said video program.

28. The system of claim 27 wherein said selected portion of said time sensitive information is displayed as a banner across a portion of a display screen.

29. The system of claim 27 wherein said selected portion of said time sensitive information is displayed as a picture-in-picture display.

30. The system of claim 27 wherein said selected portion of said time sensitive information is displayed as text moving across a bottom portion of a display screen.

31. The system of claim 25 wherein said time sensitive information includes stock market price information.

32. The system of claim 31 wherein said selected portion of said time sensitive information includes price information associated with a selected stock symbol.

33. The system of claim 25 wherein said transmission medium includes at least one digital cable television distribution network.

34. The system of claim 25 wherein said transmission medium includes the Internet.

35. The system of claim 25 wherein said data base is a first data base, further comprising a second data base for storing detailed time insensitive information collected from at least one source of time insensitive information, wherein said transmission system is further operative for providing said time insensitive information to said plurality of clients in a client generic format such that a client selects a portion of said detailed time insensitive information for viewing.

36. The system of claim 35 wherein said at least one source of time insensitive information is also one of said at least one sources of time sensitive information.

37. The system of claim 25 wherein said client generic format of said time sensitive information includes a sequence of entries each corresponding to an identifier enabling a subscribing client to retrieve a selected entry using said corresponding identifier.

38. The system of claim 37 wherein said identifier is a stock symbol.

39. The system of claim 38 wherein said selected entry includes price information corresponding to said stock symbol.

40. The system of claim 39 wherein said price information includes bid price, ask price, last price, high price of the day and low price of the day.

41. A method for real time display of time sensitive information, comprising the steps of:
receiving first set of time sensitive information;
selecting a second set of information from the first set of time sensitive information, the second set of information corresponding to a stored set of information identifiers;
storing the second set of information; and
displaying the second set of information.

42. The method of claim 41, wherein the first set of time sensitive information is stock quote information.

43. The method of claim 41, wherein the first set of time sensitive information is news information.

44. The method of claim 41, wherein the first set of time sensitive information is traffic information.

45. The method of claim 41, wherein the first set of time sensitive information is sports scores information.

46. A digital data receiver system capable of receiving time sensitive information from a digital broadcast system, comprising:
a tuner for receiving a digital data signal, said digital data signal including first time sensitive data and second time sensitive data;
a processor operative to retrieve said first time sensitive data from said data signal; and
a display device for displaying said first time sensitive data without displaying said second time sensitive data.

47. The apparatus of claim 46, wherein said digital data receiver system is a set-top-box configured to be connected with a video display monitor.

48. The apparatus of claim 47 wherein said video display monitor includes a television set.

49. The apparatus of claim 46 wherein said digital data signal includes a sequence of data packets, wherein a first data packet contains said first time sensitive information and a second data packet contains said second time sensitive information.

50. The apparatus of claim 46 wherein said,first time sensitive information includes at least one stock price associated with a first selected stock symbol and wherein said second time sensitive information includes at least one stock price associated with a second selected stock symbol.

51. The apparatus of claim 46 wherein said first time sensitive information includes at least one temperature associated with a first selected geographical location and wherein said second time sensitive information includes at least one temperature associated with a second geographical location.

52. A uni-directional broadcast server system for providing real-time stock price quotes to a plurality of clients, the system comprising:
a stock price information distribution center communicatively coupled with a stock exchange service provider, wherein said stock market service provider provides stock market information associated with a plurality of stock symbols to said stock price information distribution center;
a data base for storing said stock market information;
a uni-directional transmission system for transmitting said stock market information including a plurality of stock price quotes via a transmission medium to said plurality of clients in a client generic format such that each client receives said plurality of stock price quotes without the need for said stock price information distribution center to receive information directly from said clients;
wherein a first client selects a stock price quote for viewing; and
wherein a client processor retrieves said selected stock price quote from said received client generic stock market information and displays said selected stock price quote for viewing by said first client.

53. A digital stock price distribution system for providing real-time stock information to a plurality of clients in a uni-directional client generic manner, the system comprising:
a stock market information distribution center communicatively coupled with a stock exchange service provider, wherein said stock exchange service provider provides stock market information associated with a plurality of stock symbols to said stock market information distribution center;
a uni-directional transmission system for parsing said stock market information into a plurality of digital data packets, wherein each data packet includes a plurality of real-time stock prices associated with selected stock symbols; wherein said transmission system transmits said plurality of digital data packets to a plurality of clients in a client generic manner, wherein said transmission system updates said real-time stock prices at a predetermined time interval;
wherein a selected client receives said plurality of digital data packets and selects a stock symbol, wherein a client processor retrieves a real-time stock price associated with said selected stock symbol from a selected digital data packet in response to said client selection; and
wherein said retrieved real-time stock price is displayed to said selected client.

54. A stock information user interface for providing stock prices to a plurality of users, the user interface comprising:
software residing on a client computer system for receiving client requests for real-time price quotes for a plurality of selected stocks; and
wherein said client computer system is operative to receive a uni-directional client generic transmission of data packets from a stock price distribution service provider in the form of a stream of data packets containing stock price data, each data packet including a plurality of stock price quotes associated with a plurality of stock symbols; wherein said data contained within said stream of data packets is updated at a regular time interval in order to insure that said stock price data is up to date; wherein said client computer system is further operative to retrieve selected stock price data associated with said plurality of selected stocks from said stream of data packets and display the said selected stock price data as a banner on a display screen such that said client may view said selected stock price data in conjunction with other non-stock related data.
